(19) United States
(12) Patent Application Publication
(10) Pub. No.: US 2020/0085076 A1
(43) Pub. Date: Mar. 19, 2020

(54) NON-DAIRY CONFECTIONERY PRODUCT

(71) Applicant: PANDA VEGAN PRODUCTS LTD, Jerusalem (IL)

(72) Inventor: DANIEL BAREKET, JERUSALEM (IL)

(73) Assignee: PANDA VEGAN PRODUCTS LTD, Jerusalem (IL)

(21) Appl. No.: 16/493,308

(22) PCT Filed: Mar. 14, 2018
(86) PCT No.: PCT/IL2018/050299

§ 371 Date: Sep. 12, 2019

Related U.S. Application Data
(60) Provisional application No. 62/470,966, filed on Mar. 14, 2017.

(51) Int. Cl. A23G 1/48; A23G 1/44; A23G 3/44; A23L 29/10

(52) U.S. Cl. CPC A23G 1/48; A23L 29/10; A23G 3/44; A23G 1/44

(57) ABSTRACT

The present invention relates to non-dairy and/or vegan confectionery products, especially chocolate based products and methods of their preparation.

### TECHNOLOGICAL FIELD

The present invention is directed to non-dairy and/or vegan confectionery products, especially chocolate based products.

### BACKGROUND

Chocolate is produced from the seed of the cacao tree, typically grown in tropical regions such as Central America, the Caribbean, Indonesia, and Africa. The harvested cocoa beans are allowed to ferment for 3 to 7 days and then dried. After fermentation beans must be sorted, cleaned, and weighed before roasting. After roasting, the beans enter a machine that cracks the seed coats and blows them away, leaving behind cacao nibs, which are 47% cocoa solids and 53% cocoa butter.

Cocoa butter is the main source of fat in chocolate. The cocoa solids are ground into cocoa powder. Cacao nibs left after bean cracking can be milled into a “nut butter”-like paste, called chocolate liquor (alcohol free), which can then be pressed. The chocolate liquor can be combined with other ingredients like sugar, vanilla, and lecithin to make a more palatable product, and/or be broken down on machinery and kneaded for days to improve the texture. Careful heating and cooling will create a stable structure.

Chocolate was shown to have health benefits including, effects on people's moods, improvement of cognitive performance, it contains natural antioxidants (flavonoids) and it was shown to reduce blood pressure.

Types of chocolate products include: unsweetened chocolate that is made from 100% cocoa liquor and bitter unless mixed with other ingredients; bittersweet, semisweet, or dark chocolate that contains no milk powder and must have a minimum of 35% cocoa solids. However, by far, the most popular chocolate product is milk chocolate that contains at least 10% chocolate liquor and 12% milk solids. For people who are lactose intolerance or avoid consumption of animal product and by-product, it is essential to find a non-dairy replacement for milk chocolate, that provides the same sensation and taste without the dairy components.

### GENERAL DESCRIPTION

The invention provides a confectionery product comprising: (a) at least one cocoa component; (b) at least one coconut component; (c) at least one non-dairy vegan source dried powder; (d) at least one flavoring component; and (e) optionally at least one emulsifier component; wherein said confectionery product is a non-dairy product.

The invention provides a confectionery product comprising: (a) at least one cocoa component; (b) at least one coconut component; (c) tofu/soy powder; (d) at least one flavoring component; and (e) optionally at least one emulsifier component; wherein said confectionery product is a non-dairy product.

The invention provides a confectionery product comprising: (a) at least one cocoa component; (b) at least one non-dairy vegan source dried powder; (c) at least one flavoring component; and (d) optionally at least one emulsifier component; wherein said confectionery product is a non-dairy product.

The invention provides a confectionery product comprising: (a) at least one cocoa component; (b) tofu/soy powder; (c) at least one flavoring component; and (d) optionally at least one emulsifier component; wherein said confectionery product is a non-dairy product.

The term “confectionery product” should be understood to encompass in the context of the present invention, any candy based edible product that is substantially sweetened (either by sugar or sugar replacements) and has the taste of chocolate. In some embodiments, said confectionery product of the invention has the feel (taste, smell, look, consistency and so forth) of milk chocolate, although it is a non-dairy product (i.e. dairy free). A confectionery product of the invention may be consumed by a subject either as is (ready to eat/consume) or is prepared in any known process (such as heating, cooling, cooking, baking, frying, steaming, mixing with other food ingredients, mixing with hot or cold liquids, and so forth).

The term “cocoa component” should be understood to encompass a component of the product that provides its cocoa base. This component comprises one or more cocoa based element derived from any part of the cocoa bean, which is dairy free. Said cocoa component may be in the solid form, in the liquid form, in a semi-solid form, semi-liquid form or any combinations thereof.

In some embodiments, said at least one cocoa component comprises at least one of cocoa liquor, cocoa powder, cocoa butter, cocoa solids, and any combinations thereof.

The term “coconut component” should be understood to encompass a component of the product that provides its coconut base. This component comprises one or more coconut based element derived from any part of the coconut fruit, which is dairy free. Said coconut component may be in the solid form, in the liquid form, in a semi-solid form, semi-liquid form or any combinations thereof.

In some embodiments, said at least one coconut component comprises at least one of coconut oil, coconut butter, coconut milk, coconut cream, coconut powder, coconut nectar, coconut shards, coconut fiber, dried coconut and any combinations thereof.

The term “non-dairy, vegan source dried powder” should be understood to encompass a dry powder of any type of non-dairy souce (for example non-dairy milk of soy, nut or grain) and/or vegan souce (for example protein extract of legume and/or grain). In some embodiments said non-dairy, vegan source dried powder is selected from tofu/soy powder, dried non-dairy milk powder, dried protein extract/concentrate of legume, dried protein extract/concentrate of grain and any combinations thereof. It is noted that the non-dairy vegan souce dried powder is dried in any form known in the art, including but not limited to heating, freeze drying, spray drying, and so forth.

The term “tofu/soy powder” should be understood to encompass a dry powder of soy bean curd. The tofu/soy powder is made from either dried and grinded tofu (bean curd made by coagulating soy milk) or from a dried and grinded soy milk. It should be understood that tofu/soy powder is different than soy flour that is made from roasted and grinded soy beans.

The term “dried non-dairy milk powder” should be understood to encompass a dry powder of non-dairy milk made of any vegan souce, including but not limited to nut based milk, grain based milk, cereal based milk and any combinations thereof. In some none limiting examples, said vegan or non-dairy milk is selected from almond milk, hazelnut milk, hemp milk, oat milk, rice milk, cashew milk, macademia nut milk, flax milk and any combinations thereof.

When referring to legume it should be understood to relate to a plant or its fruit or seed in the family Fabaceae (or Leguminosae). None limiting examples of legumes include peas, beans, chickpeas, lentils, lupin bean, mesquite, peanuts tamarind and any combinations thereof. In some embodiments, said dried protein powder from legume source is dried protein powder from chickpea.

When referring to grain it should be understood to relate to cereal grain, including but not limited to rice, oat, buckwheat, and any combinations thereof.

It shoud be noted that the extract/concentrate of protein from said legume and/or grain souce is being produced by any process known in the art, such as for example provided in J. Gueguen “Legume seed protein extraction, processing, and end product characteristics”, Plant Foods for Human Nutrition, 1983, Volume 32(3-4), pp 267-303.

In some embodiments, a confectionery product of the invention comprises at least one non-dairy vegan souce dried powder in an amount of at least 5% by weight of the product. In some embodiments, a confectionery product of the invention comprises at least one non-dairy vegan souce dried powder in an amount of at least 10% by weight of the product. In other embodiments, a confectionery product of the invention comprises at least one non-dairy vegan souce dried powder in an amount of between 5% by weight to 30% by weight of the product.

In some embodiments, a confectionery product of the invention comprises tofu/soy powder in an amount of at least 5% by weight of the product. In some embodiments, a confectionery product of the invention comprises tofu/soy powder in an amount of at least 10% by weight of the product. In other embodiments, a confectionery product of the invention comprises tofu/soy powder in an amount of between 5% by weight to 30% by weight of the product.

The term “flavoring component” should be understood to encompass a component of the product that provides its additional flavoring feature (in addition to the cocoa and coconut components). This component comprises one or more flavoring elements, which is dairy free. Said flavoring component may be in the solid form, in the liquid form, in a semi-solid form, semi-liquid form or any combinations thereof.

In some embodiments said at least one flavoring component comprises at least one of a sweetener, at least one spice ingredient, at least one fruit ingredient, at least one nut ingredient and any combinations thereof.

The term “emulsifier component” as used herein should be understood to encompass a food grade component of a product of the invention that is capable of mixing at least two immiscible components (in some embodiments two liquids or semi-solids, such as for example an oily based component and an aqueous based component) into a substantially stable emulsion. This component is optional in a product of the present invention. In some embodiments, a product of the present invention comprises at least one emulsifier component.

In some embodiments, said at least one emulsifier component comprises at least one of lecithin, ester of monoglycerides of fatty acid, mono- and diglycerides of fatty acids, calcium stearoyl di laciate, polyglycerol ester (PGE), sorbitan ester (SOE), PG ester (PGME), sugar ester (SE), monoglyceride (MG), acetylated monoglyceride (AMG), lactylated monoglyceride (LMG) and any combinations thereof.

In some embodiments, a confectionery product of the invention may further comprise at least one vegetable fat extract (such as for example any type of vegetable oil, coconut oil, palm oil and their derivatives).

In some embodiments a confectionery product of the invention is a vegan product (i.e. a confectionery product of the invention is free of any elements derived directly or indirectly from animals).

In some embodiments a confectionery product of the invention is in a form selected from solid, powder, liquid, semi-solid.

The invention further provides a food product that comprises at least one confectionery product of the invention as disclosed herein above. Said food product is either a baked product, a cooked product, a steamed product, a fried product, a mixed product. In some embodiments a food product as disclosed herein is prepared in any known process (such as heating, cooling, cooking, frying, steaming, baking, mixing with other food ingredients, mixing with hot or cold liquids, and so forth).

The invention further provides a process for the preparation of a non-dairy confectionery product, comprising the steps of (i) mixing at least one cocoa component; at least one coconut component; at least one non-dairy vegan souce dried powder; at least one flavoring component; and optionally at least one emulsifier component, thereby forming a mixture (ii) setting said mixture to solidify thereby producing said confectionery product.

The invention further provides a process for the preparation of a non-dairy confectionery product, comprising the steps of (i) mixing at least one cocoa component; at least one coconut component; tofu/soy powder; at least one flavoring component; and optionally at least one emulsifier component, thereby forming a mixture (ii) setting said mixture to solidify thereby producing said confectionery product.

In some embodiments, said mixing step further comprises grinding said mixture.

In other embodiments, said mixing step further comprises heating said mixture to a temperature wherein said mixture is in a liquid form.

In further embodiments, said setting step is performed in a mold.

In yet other embodiments, a process of the invention further comprises a step of grinding said confectionery product to a powder.

### DETAILED DESCRIPTION OF EMBODIMENTS

The following describes a non-limiting example of a process for obtaining the confectionary product of the present disclosure.

### Example 1

The cocoa ingredients, cocoa solids, cocoa butter (26% wt) and cocoa liquor (13% wt), were melted at a temperature of about 45 C and then were introduced into a refiner for grinding and mixing to form a uniform cocoa mixture. The dry ingredients, soy (20% wt), sugar (38% wt) and coconut (2% wt), were introduced into and mixed with the uniform cocoa mixture and then the mixture was left untouched for 4 hours at a temperature of 45 C. At the end of 4 hours, lecithin (0.4% wt) and flavor ingredients (0.01% wt) were introduced into and mixed with the mixture. The mixture was then left untouched for additional 3 hours at a temperature of 45 C after which it was cooled down in forms for obtaining the final product.

1. A confectionery product comprising:
(a) a cocoa component;
(b) a coconut component;
(c) tofu/soy powder;
(d) a flavoring component; and
(e) optionally an emulsifier component;
wherein said confectionery product is a non-dairy product.

2. A confectionery product according to claim 1, wherein said cocoa component comprises at least one of cocoa liquor, cocoa powder, cocoa butter, cocoa solids, and any combinations thereof.

3. A confectionery product according to claim 1, wherein said coconut component comprises at least one of coconut oil, coconut butter, coconut milk, coconut cream, coconut powder, coconut nectar, coconut shards, coconut fiber, dried coconut and any combinations thereof.

4. A confectionery product according to claim 1, comprising at least one emulsifier.

5. A confectionery product according to claim 1, further comprising at least one vegetable fat extract.

6. A confectionery product according to claim 1, having said tofu/soy powder in an amount of at least 5% by weight of the product.

7. A confectionery product according to claim 1, having said tofu/soy powder in an amount of between 5% by weight to 30% by weight of the product.

8. A confectionery product according to claim 1, wherein said at least one flavoring component comprises at least one of a sweetener, at least one spice ingredient, at least one fruit ingredient, at least one nut ingredient and any combinations thereof.

9. A confectionery product according to claim 1, wherein said at least one emulsifier component comprises at least one of lecithin, ester of monoglycerides of fatty acid, mono- and diglycerides of fatty acids calcium stearoyl di laciate, polyglycerol ester (PGE), sorbitan ester (SOE), PG ester (PGME), sugar ester (SE), monoglyceride (MG), acetylated monoglyceride (AMG), lactylated monoglyceride (LMG) and any combinations thereof.

10. A confectionery product according to claim 1, being a vegan product.

11. A confectionery product according to claim 1, being in a form selected from solid, powder, liquid, semi-solid.

12. A food product comprising said confectionery product according to claim 1.

13. A process for the preparation of a non-dairy confectionery product, comprising the steps of (i) mixing a cocoa component; a coconut component; tofu/soy powder; a flavoring component; and optionally an emulsifier component, thereby forming a mixture (ii) setting said mixture to solidify thereby producing said confectionery product.

14. A process according to claim 13, wherein said mixing step further comprises grinding said mixture.

15. A process according to claim 13, wherein said mixing step further comprises heating said mixture to a temperature wherein said mixture is in a liquid form.

16. A process according to claim 13, wherein said setting is performed in a mold.

17. A process according to claim 13, further comprising grinding said confectionery product to a powder.
